(19) United States
(12) Patent Application Publication
(10) Pub. No.: US 2024/0281957 A1
(43) Pub. Date: Aug. 22, 2024

(54) INFORMATION PROCESSING DEVICE AND STORAGE MEDIUM

(71) Applicant: SEIKO EPSON CORPORATION, TOKYO (JP)

(72) Inventor: Ryotaro HAYASHI, SHIOJIRI-SHI (JP)

(21) Appl. No.: 18/443,593

(22) Filed: Feb. 16, 2024

(30) Foreign Application Priority Data
Feb. 17, 2023 (JP) 2023-023219

(51) Int. Cl. G06T 7/00; G06T 7/90; H04N 1/00; H04N 1/60

(52) U.S. Cl. CPC G06T 7/0008; G06T 7/90; H04N 1/00023; H04N 1/60; G06T 2207/10024; G06T 2207/30144

(57) ABSTRACT

An information processing device includes an obtainer configured to obtain color information of a spot color patch targeted for a color difference inspection and inspection result information indicating a result of the color difference inspection for the spot color patch, a determiner configured to determine, among colors included in image data, a color to be printed as the spot color patch based on the color information and the inspection result information, and a print controller configured to cause a printing device to print the image data and the spot color patch of the color determined by the determiner. The determiner is configured to change the number of colors to be printed as the spot color patch based on the inspection result information on the colors included in the image data.

The present application is based on, and claims priority from JP Application Serial Number 2023-023219, filed Feb. 17, 2023, the disclosure of which is hereby incorporated by reference herein in its entirety.

### BACKGROUND

### 1. Technical Field

The present disclosure relates to an information processing device and a storage medium.

### 2. Related Art

In existing techniques, a color called a spot color may be included in print data. A spot color is a color desired to be reproduced with high accuracy on a print medium. Therefore, the shade, tone, or tint of a spot color in a printing result may be evaluated by printing spot color patches, which are patches of the spot color, on a print medium and performing colorimetry on the spot color patches.

JP-A-2012-80505 discloses an image processing device that outputs data representing a test chart.

The image processing device includes an outputting section, an acquiring section, and a control section.

The outputting section outputs data representing the test chart that includes a plurality of patches respectively having gradation values that are different from each other and are extended in the main-scanning direction.

The acquiring section acquires a measured result of measuring a density of each of the patches included in the test chart printed by the printing apparatus based on the data outputted by the outputting section.

The control section compares in the main-scanning direction the density unevenness of a pair of patches being adjacent to each other among the plurality of patches included in the printed test chart, wherein the density unevenness of the pair of patches are derived from the measured result acquired by the acquiring section, and determines new data representing a next patch to be outputted on a next occasion by the outputting section, based on the comparison result.

However, it is not efficient to increase the number of colors of patches that are desired to be inspected and that are included in a print image printed in accordance with print data.

### SUMMARY

The present disclosure is an information processing device including an obtainer configured to obtain color information of a patch targeted for a color difference inspection and inspection result information indicating a result of the color difference inspection for the patch, a determiner configured to determine, among colors included in image data, a color to be printed as the patch based on the color information and the inspection result information, and a print controller configured to cause a printing device to print the image data and the patch of the color determined by the determiner. The determiner is configured to change the number of colors to be printed as the patch based on the inspection result information on the colors included in the image data.

The present disclosure is a non-transitory computer-readable storage medium storing a program that causes a computer to function as an obtainer configured to obtain color information of a patch targeted for a color difference inspection and inspection result information indicating a result of the color difference inspection for the patch, a determiner configured to determine, among colors included in image data, a color to be printed as the patch based on the color information and the inspection result information, and a print controller configured to cause a printing device to print the image data and the patch of the color determined by the determiner. The determiner is configured to change the number of colors to be printed as the patch based on the inspection result information on the colors included in the image data.

### BRIEF DESCRIPTION OF THE DRAWINGS

FIG. 1 is a diagram illustrating a system configuration.

FIG. 2 illustrates a color wheel.

FIG. 3 depicts a print image printed in accordance with print data.

FIG. 4 is a flowchart illustrating operations of an information processing device.

FIG. 5 is a flowchart illustrating operations of the information processing device.

FIG. 6 is a flowchart illustrating operations of the information processing device.

FIG. 7 is a flowchart illustrating operations of the information processing device.

FIG. 8 is a block diagram illustrating another configuration of the information processing device.

### DESCRIPTION OF EMBODIMENTS

Embodiments will be described hereafter with reference to the accompanying figures.

### 1. SYSTEM CONFIGURATION

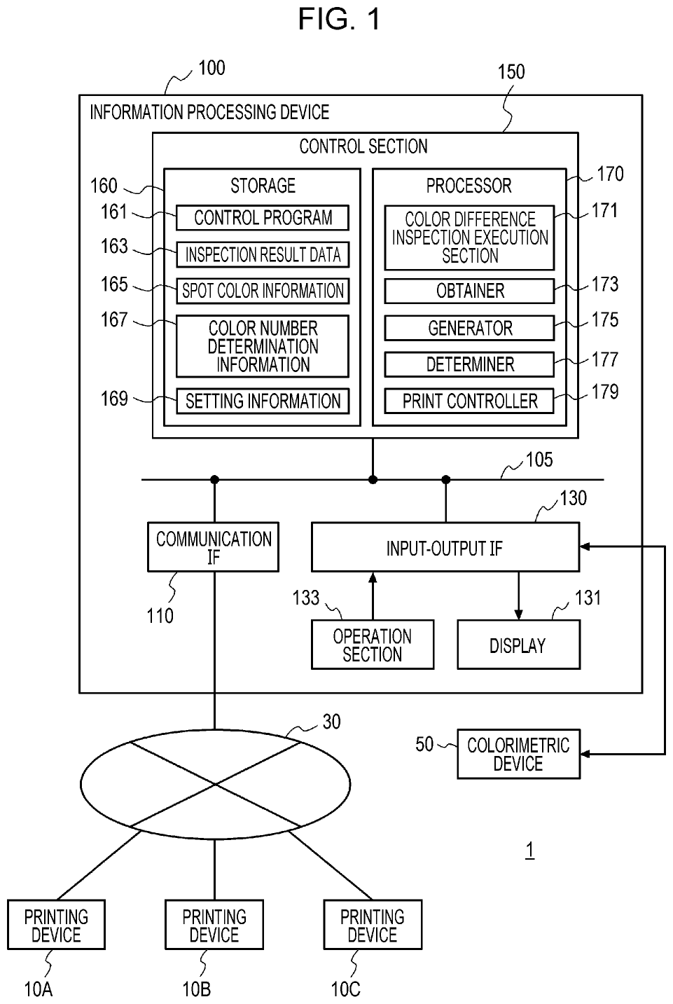

FIG. 1 is a diagram illustrating a system configuration according to the present embodiment.

A system 1 according to the present embodiment has a configuration in which a plurality of printing devices 10 and an information processing device 100 are connected via a network 30.

The network 30 is a wired or wireless transmission path of information transmitted from a device coupled to the network 30. Examples of the network 30 may include various types of local area networks (LANs) including Ethernet, and wide area networks (WANs). Ethernet is a registered trademark.

The printing device 10 is a device that prints an image based on print data received from the information processing device 100 on a print medium. Although FIG. 1 illustrates a configuration in which three printing devices 10, printing devices 10A, 10B, and 10C, are coupled to the network 30, the number of printing devices 10 coupled to the network 30 is arbitrary. In addition, although FIG. 1 illustrates a configuration in which the printing devices 10A, 10B, and 10C are coupled to the network 30 in a wired manner, the coupling configuration between the printing devices 10A, 10B, and 10C and the network 30 may be wireless.

In addition, the printing devices 10A, 10B, and 10C are hereafter collectively referred to as the printing device 10.

The information processing device 100 transmits print data to the printing device 10 coupled to the network 30 so as to cause the printing device 10 to print the print data. As the information processing device 100, for example, a tablet personal computer (PC), a notebook PC, a desktop PC, or a smartphone is used.

### 2. CONFIGURATION OF INFORMATION PROCESSING DEVICE

The information processing device 100 includes a communication interface 110, an input-output interface 130, a display 131, an operation section 133, and a control section 150. Interface is hereafter abbreviated to I/F.

The communication I/F 110, the input-output I/F 130, and the control section 150 are coupled via a bus 105 to be capable of performing data communication with each other. The communication I/F 110 includes a connector and an interface circuit and is coupled in a wired manner to the network 30. The communication I/F 110 includes, for example, a network interface card (NIC) as the interface circuit.

The input-output I/F 130 includes a connector and an interface circuit. The display 131, the operation section 133, and a colorimetric device 50 are coupled to the input-output I/F 130. The input-output I/F 130 is, for example, a universal serial bus (USB) interface compliant with USB standards.

The display 131 includes, for example, a display panel, such as a liquid crystal panel, and displays information, such as an image or a character, on the display panel under the control of the control section 150. The display panel is not illustrated in the figure.

The operation section 133 is a section for inputting user operations. The operation section 133 includes, for example, various buttons such as numeric keys and a directional pad (D-pad). The various buttons are not illustrated in the figure. Pushing a button included in the operation section 133 causes an operation signal corresponding to the pushed button to be output to the control section 150.

The colorimetric device 50, which includes a colorimetric sensor, performs colorimetry of the color of a spot color patch printed on a print medium by the printing device 10. The colorimetric device 50 outputs a colorimetric value, which represents the color of the spot color patch, obtained by performing the colorimetry to the information processing device 100. The format of a colorimetric value obtained and output as a colorimetric result by the colorimetric device 50 may be, for example, a format representing the value in the L*a*b* color space defined by International Commission on Illumination (CIE). In addition, the format of the colorimetric value may be an RGB format that is a combination of grayscale values of red (R), green (G), and blue (B). Hereafter, a description is given of the case where the format of a colorimetric value output by the colorimetric device 50 is RGB.

The control section 150 is a computer device including a storage 160 and a processor 170.

The storage 160 includes a volatile storage device and a nonvolatile storage device.

The volatile storage device is constituted by, for example, a random-access memory (RAM). The nonvolatile storage device is constituted by, for example, a read-only memory (ROM), a flash memory, or an electrically erasable programmable read-only memory (EEPROM).

The volatile storage device is used as an operation area of the processor 170.

The nonvolatile storage device stores a control program 161, inspection result data 163, spot color information 165, color number determination information 167, and setting information 169.

The control program 161 is a program that is executed by the processor 170. The processor 170 controls various types of processing performed by the information processing device 100 by executing operations according to the control program 161. The inspection result data 163 is data indicating an inspection result of a color difference inspection performed by the control section 150.

The control section 150 performs a color difference inspection of the colorimetric value of a spot color patch input from the colorimetric device 50 to generate the inspection result data 163. The inspection result data 163 includes color information indicating the color of the spot color patch, the model information of the printing device 10, and medium information indicating a print medium on which the spot color patch is printed.

The spot color information 165 is color information indicating the color of a spot color. The spot color is a predetermined color desired by the user to be reproduced with high accuracy on a print medium. In addition, the spot color may be a color produced by using a spot color ink. The spot color ink is the ink of a spot color other than cyan, magenta, yellow, and black that constitute a process color, or a liquid for achieving special visual effects. A metallic ink is an example of the ink of a spot color. A clear ink is an example of the liquid for achieving special visual effects. For the spot color information 165, the user may operate the operation section 133 to set a color to be specified as the spot color.

The color number determination information 167 is information by which the number of spot color patches to be printed by the printing device 10 is determined. The color number determination information 167 includes area information, model information, and medium information.

The area information is information indicating an area of a color wheel 500.

Examples of the area of the color wheel 500 indicated by the area information include a first area and a second area.

The first area is an area of the color wheel 500 in which a color difference is likely to occur in a color difference inspection. The second area is an area of the color wheel 500 in which a color difference is unlikely to occur in a color difference inspection. In addition, in the present embodiment, the area of the color wheel 500 other than the first area and the second area is referred to as a third area.

The color number determination information 167 is registered such that the model information and the medium information are associated with area information indicating the first area. The color number determination information 167 is also registered such that the model information and the medium information are associated with area information indicating the second area.

The model information associated with the area information indicating the first area is model information included in the inspection result data 163 that has been determined by a color difference inspection to belong to the first area. That is, this model information is information indicating the model of the printing device 10 that has printed a spot color classified into the first area. The medium information associated with the area information indicating the first area is medium information included in the inspection result data 163 that has been determined by a color difference inspection to belong to the first area. That is, this medium information is information indicating a print medium on which a spot color classified into the first area is printed.

The model information associated with the area information indicating the second area is model information included in the inspection result data 163 that has been determined by a color difference inspection to belong to the second area. That is, this model information is information indicating the model of the printing device 10 that has printed a spot color classified into the second area. The medium information associated with the area information indicating the second area is medium information included in the inspection result data 163 that has been determined by a color difference inspection to belong to the second area. That is, this medium information is information indicating a print medium on which a spot color classified into the second area is printed.

The setting information 169 is information indicating settings of various operations performed by the information processing device 100 and thresholds. The setting information 169 includes a first threshold, a second threshold, a color difference threshold, and so on described later.

The processor 170 is a processing device including a processor such as a central processing unit (CPU) or a micro-processing unit (MPU). The processor 170 may be a single processor or may be constituted by a plurality of processors. In addition, the processor 170 may be constituted by a system-on-a-chip (SoC) integrated with part or whole of the storage 160 and other circuits. In addition, the processor 170 may be constituted by a combination of a CPU, which executes a program, and a digital signal processor (DSP), which executes predetermined arithmetic processing. Furthermore, the processor 170 may be configured such that all of the functions of the processor 170 are implemented as hardware, and may also be configured using programmable devices.

The control section 150 includes, as functional blocks, a color difference inspection execution section 171, an obtainer 173, a generator 175, a determiner 177, and a print controller 179. These functional blocks are blocks representing functions that are performed when the processor 170 executes the control program 161.

The colorimetric value of a spot color patch obtained by colorimetry performed by the colorimetric device 50 is input to the color difference inspection execution section 171.

First, the information processing device 100 transmits print data including spot color patch data, which is data on a spot color patch, and a specification of a print medium to the printing device 10. When a colorimetric value is input from the colorimetric device 50, the color difference inspection execution section 171 obtains the color information of a spot color patch included in the print data and performs a color difference inspection for the input colorimetric value of the spot color patch to generate the inspection result data 163. The color difference inspection is performed by determining whether a color difference between the input colorimetric value and the color of a spot color indicated by the spot color information 165 is greater than a color difference threshold set in advance.

In addition, when the print data includes a plurality of spot color patches, for example, information indicating the order of colorimetry processes performed for the plurality of spot color patches included in the print data may be included in the print data. In this case, according to the order of colorimetry processes performed for spot color patches based on the print data and displayed in a print image, the user performs colorimetry on the spot color patches.

Upon determining that the color difference between the input colorimetric value and the color of a spot color indicated by the spot color information 165 is greater than or equal to the color difference threshold, the color difference inspection execution section 171 determines that an inspection result of the color difference inspection is defective.

The color difference inspection execution section 171 generates the inspection result data 163 including color information, the model information, and the medium information. The color information indicates the color of a spot color patch for which it is determined that an inspection result of the color difference inspection is defective. The color difference inspection execution section 171 causes the generated inspection result data 163 to be stored in the storage 160.

The color information of a spot color patch included in the inspection result data 163 is information indicating the color of a spot color patch from which the color difference of the input colorimetric value has been determined.

The model information included in the inspection result data 163 is information indicating the model of the printing device 10 that has printed the spot color patch, and the medium information included in the inspection result data 163 is information indicating a print medium on which the spot color patch has been printed.

The obtainer 173 obtains the inspection result data 163 from the storage 160. The obtainer 173 outputs the obtained inspection result data 163 to the generator 175.

The generator 175 generates the color number determination information 167 based on the inspection result data 163 obtained by the obtainer 173.

When the number of pieces of the inspection result data 163 is greater than or equal to a set number, the generator 175 generates the color number determination information 167 based on the inspection result data 163.

The generator 175 converts the color information of a spot color included in each piece of the inspection result data 163 input from the obtainer 173 to color information in the HSV format by using a predetermined calculation formula. The generator 175 plots the spot color on the color wheel 500 based on the hue and saturation included in the color information converted to the HSV format. Regarding the term HSV, H, S, and V are abbreviated names for hue, saturation, and value, respectively.

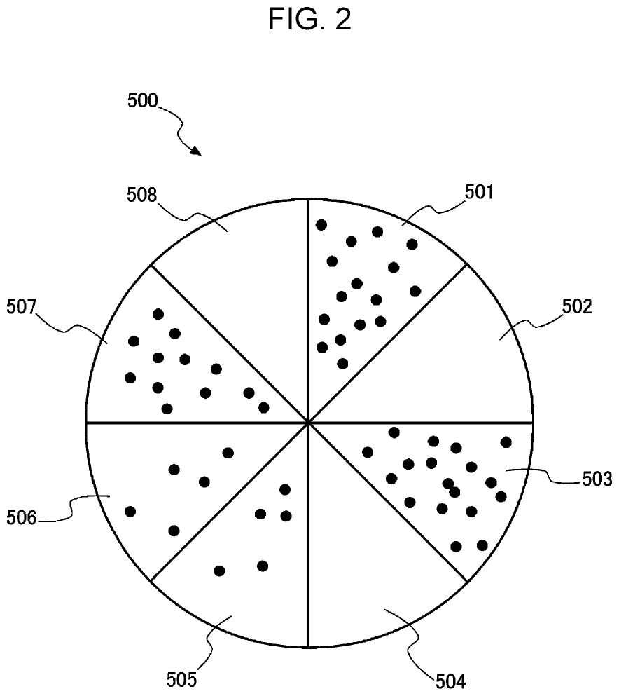

FIG. 2 illustrates spot colors plotted on the color wheel 500.

The color wheel 500 is divided by the number of divisions set in advance. The color wheel 500 illustrated in FIG. 2 is exemplarily divided into eight areas; however, the number of divisions of the color wheel 500 is arbitrary.

Upon plotting spot colors, each of which is indicated by the color information included in the input inspection result data 163, on the color wheel 500, the generator 175 detects an area in which the number of plots of the spot colors is greater than or equal to the first threshold. The generator 175 determines, as the first area, an area in which the number of plots of the spot colors is greater than or equal to the first threshold. The first threshold is a threshold to be used for determining an area where a color difference is likely to be produced.

In the example of the color wheel 500 illustrated in FIG. 2, three areas, areas 501, 503, and 507, are determined as the first areas.

The generator 175 also detects an area in which the number of plots of the spot colors is less than or equal to the second threshold. The second threshold is a threshold having a value less than the first threshold. The second threshold is a threshold to be used for determining a second area where a color difference is unlikely to be produced. In the example of the color wheel 500 illustrated in FIG. 2, three areas, areas 502, 504, and 508, are determined as the second areas.

Upon determining the first area, the generator 175 associates area information, which indicates the range of the determined first area, with the model information and the medium information to generate the color number determination information 167. The generator 175 obtains the inspection result data 163 including the color information of each of the spot color patches determined to belong to the first area. The generator 175 generates the color number determination information 167 by associating the model information and the medium information included in the obtained inspection result data 163 with the area information of the first area. The generator 175 causes the generated color number determination information 167 to be stored in the storage 160.

In addition, upon determining the second area, the generator 175 associates area information, which indicates the range of the determined second area, with the model information and the medium information to generate the color number determination information 167. The generator 175 obtains the inspection result data 163 including the color information of each of the spot color patches determined to belong to the second area. The generator 175 generates the color number determination information 167 by associating the model information and the medium information included in the obtained inspection result data 163 with the area information of the second area. The generator 175 causes the generated color number determination information 167 to be stored in the storage 160.

The determiner 177 obtains the color number determination information 167 from the storage 160 and determines the color of a spot color patch to be printed on a print medium based on the obtained color number determination information 167.

When the operation section 133 receives an operation of providing an instruction to perform printing, the determiner 177 determines whether a spot color is included in image data selected by the received operation.

If a spot color is not included in the image data, the determiner 177 outputs the image data just as is to the print controller 179.

In addition, if a spot color is included in the image data, the determiner 177 determines whether a plurality of spot colors are included in the image data. If only a single spot color is included in the image data, the determiner 177 generates spot color patch data based on the color information of the single spot color. The determiner 177 adds the generated spot color patch data to the image data.

In addition, if it is determined that a plurality of spot colors are included in the image data, the determiner 177 determines an area to which the plurality of spot colors belong, based on the color number determination information 167. For example, when the format of the image data is the RGB format, the determiner 177 converts the color information of the plurality of spot colors to the HSV format representing the hue, saturation, and brightness by using a predetermined calculation formula. Referring to the color number determination information 167 based on the color information of the spot colors converted to the HSV format, the determiner 177 determines an area to which the color information of the spot colors belongs.

If, as a result of referring to the color number determination information 167 based on the color information of the spot colors converted to the HSV format, it is determined that a plurality of spot colors belong to the first area, the determiner 177 generates spot color patch data of all the spot colors belonging to the first area. The determiner 177 adds the generated spot color patch data to the image data. The determiner 177 outputs the image data with the generated spot color patch data to the print controller 179.

If, as a result of referring to the color number determination information 167 based on the color information of the spot colors converted to the HSV format, it is determined that a plurality of spot colors belong to the second area, the determiner 177 generates spot color patch data of one color selected among the colors belonging to the second area. The determiner 177 makes the number of patches of the colors included in the second area smaller than the number of patches of the colors included in the first area. The determiner 177 adds the generated spot color patch data to the image data. The determiner 177 outputs the image data with the generated spot color patch data to the print controller 179.

If, as a result of referring to the color number determination information 167 based on the color information of the spot colors converted to the HSV format, it is determined that a plurality of spot colors belong to the third area, the determiner 177 makes the number of colors for generating the spot color patch data smaller than the number of spot colors belonging to the third area. For example, if the number of spot colors determined to belong to the third area is four, spot color patch data of three colors, two colors, or one color smaller than the four colors is generated. The determiner 177 adds the generated spot color patch data to the image data. The determiner 177 outputs the image data with the generated spot color patch data to the print controller 179.

It is assumed that, as a result of referring to the color number determination information 167 based on the color information of the spot colors in the HSV format, the determiner 177 determines that, for example, one color among a plurality of spot colors belongs to the first area, another color belongs to the second area, and another color belongs to the third area. In this case, the control section 150 generates spot color patch data of the spot color belonging to the first area and spot color patch data of the spot color belonging to the third area. The determiner 177 adds the generated spot color patch data to the image data. The determiner 177 outputs the image data with the generated spot color patch data to the print controller 179.

The print controller 179 applies processing such as rasterization to the image data to which the spot color patch data has been added, thereby generating print data. The print controller 179 transmits the generated print data to the printing device 10 selected by a user operation.

In addition, the determiner 177 may determine the number of colors of spot color patches based on the model information and the medium information included in the color number determination information 167. For example, it is assumed that the printing device 10 selected by the user is the printing device 10A, and a plurality of spot colors determined to belong to the first area are included in image data to be printed by the printing device 10A.

When the model information indicates the model of the printing device 10A and when the medium information indicates a print medium to be used for printing by the printing device 10A, the determiner 177 generates the spot color patch data of all the spot colors belonging to the first area. At this point, it is assumed that the number of spot colors for generating the spot color patch data is X.

In addition, when the model information indicates the model of the printing device 10A or when the medium information indicates a print medium to be used for printing by the printing device 10A, the determiner 177 generates the spot color patch data of Y spot colors among colors determined to be spot colors belonging to the first area. At this point, it is assumed that the number of spot colors for generating the spot color patch data is Y. Y is a smaller number than X.

In addition, when the model information does not indicate the model of the printing device 10A and when the medium information does not indicate a print medium to be used for printing by the printing device 10A, the determiner 177 generates the spot color patch data of Z spot colors among colors determined to be spot colors belonging to the first area. Z is a smaller number than Y.

In addition, the determiner 177 performs similar processing when a plurality of spot colors belong to the second area or the third area.

For example, when a plurality of spot colors belong to the second area or the third area and when the model indicated by model information matches the model of the printing device 10A, the determiner 177 makes the number of patches to be printed larger than that when the model indicated by the model information does not match the model of the printing device 10A.

Similarly, when a plurality of spot colors belong to the second area or the third area and when the medium information matches a print medium to be used for printing by the printing device 10A, the determiner 177 makes the number of patches to be printed larger than that when the medium information does not match a print medium to be used for printing by the printing device 10A.

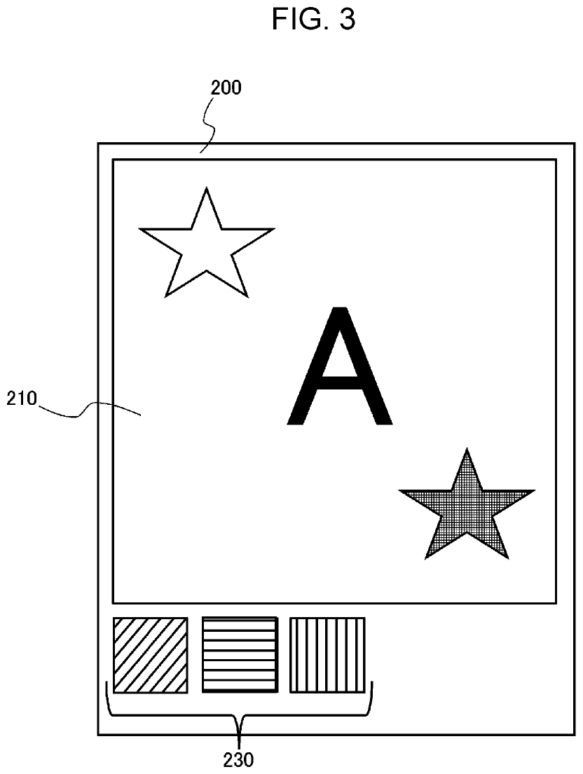

FIG. 3 depicts a print image 200 printed in accordance with print data.

The print image 200 includes an image 210 based on print data and spot color patches 230 that are images based on spot color patch data added to the print data by the printing device 10. The image 210 and the spot color patches 230 are printed on a single print medium. The spot color patches 230 are formed below the image 210 as seen on the figure. The number of spot color patches 230 formed in the print image 200 corresponds to the number of spot color patches determined by the determiner 177.

### 3. OPERATIONS OF INFORMATION PROCESSING DEVICE

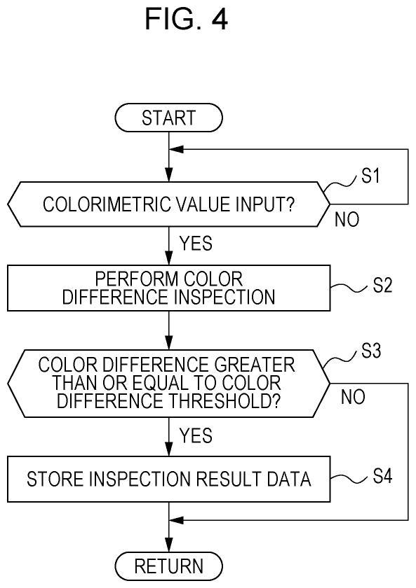

FIG. 4 is a flowchart illustrating operations of the information processing device 100. In particular, FIG. 4 is a flowchart illustrating operations of performing a color difference inspection to generate the inspection result data 163, which are performed by the information processing device 100.

With reference to the flowchart illustrated in FIG. 4, operations of the information processing device 100 will be described.

First, the control section 150 determines whether a colorimetric value is input from the colorimetric device 50 (step S1). If there is no input of a colorimetric value (No in step S1), the control section 150 waits until a colorimetric value is input.

If a colorimetric value is input from the colorimetric device 50 (Yes in step S1), the control section 150 performs a color difference inspection based on the input colorimetric value (step S2). The control section 150 determines whether the color difference between the input colorimetric value and the color value of a spot color corresponding to the colorimetric value is greater than or equal to a color difference threshold to perform a color difference inspection.

For example, in the spot color patch data that is added to image data by the control section 150, the order of colorimetry processes is set in advance. For example, an image indicating the order of colorimetry processes may be included in the spot color patch data, so that spot color patches and the number indicating the order of colorimetry processes are printed when the print data is printed by the printing device 10.

When print data generated, for example, by applying rasterization to image data is printed by the printing device 10, the user 50 causes the colorimetric device 50 to perform colorimetry of the spot color patches printed on the print medium in the order set in advance.

When a colorimetric value is input from the colorimetric device 50, the control section 150 obtains color information of a spot color corresponding to the input order of the colorimetric value and calculates a color difference between the obtained color information and the colorimetric value.

The control section 150 determines whether the calculated color difference is greater than or equal to the color difference threshold (step S3). If the calculated color difference is greater than or equal to the color difference threshold (Yes in step S3), the control section 150 generates the inspection result data 163 and causes the inspection result data 163 to be stored in the storage 160 (step S4). The inspection result data 163 includes the color information of a spot color with a color difference greater than or equal to the color difference threshold, the model information of the printing device 10, and medium information.

In addition, if the calculated color difference is less than the color difference threshold (No in step S3), the control section 150 returns to the determination at step S1 without generating the inspection result data 163.

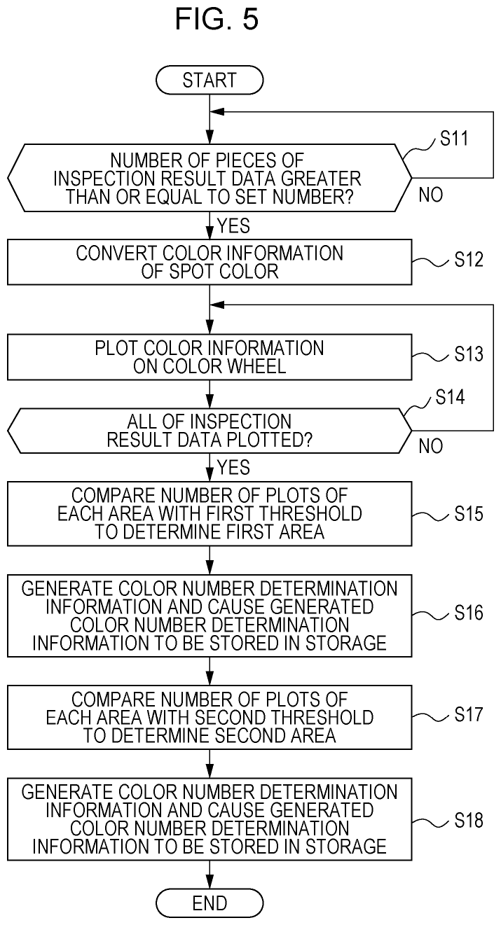

FIG. 5 is a flowchart illustrating operations of the information processing device 100. In particular, FIG. 5 is a flowchart illustrating operations of generating the color number determination information 167 based on the inspection result data 163 stored in the storage 160, which are performed by the information processing device 100.

With reference to the flowchart illustrated in FIG. 5, operations of the information processing device 100 will be described.

First, the control section 150 determines whether the number of pieces of the inspection result data 163 stored in the storage 160 is greater than or equal to a set number set in advance (step S11). If the number of pieces of the inspection result data 163 is not greater than or equal to the set number (No at step S11), the control section 150 returns to the determination in step S11.

If the number of pieces of the inspection result data 163 is greater than or equal to the set number (Yes at step S11), the control section 150 converts the color information of the spot color included in each piece of the inspection result data 163 to color information in the HSV format by using a predetermined calculation formula (step S12). The control section 150 plots the color information of each spot color converted to the HSV format on the color wheel 500 (step S13).

Then, the control section 150 determines whether all of the pieces of the inspection result data 163 have been plotted on the color wheel 500 (step S14). If all of the pieces of the inspection result data 163 have not been plotted on the color wheel 500 (No at step S14), the control section 150 returns to step S13.

If it is determined that all of the pieces of the inspection result data 163 have been plotted on the color wheel 500 (Yes at step S14), the control section 150 counts the number of plots of each of areas into which the color wheel 500 is divided, and compares the number of plots of each area with the first threshold (step S15). The control section 150 determines, as the first area, an area in which the number of plots is greater than or equal to the first threshold (step S15). The control section 150 generates the color number determination information 167 that includes the area information of the area determined as the first area and the model information and the medium information included in each piece of the inspection result data 163 plotted in this area. The control section 150 causes the generated color number determination information 167 to be stored in the storage 160 (step S16).

In addition, the control section 150 compares the counted number of plots of each area with the second threshold (step S17). The control section 150 determines, as the second area, an area in which the number of plots is less than or equal to the second threshold (step S17). The control section 150 generates the color number determination information 167 including the area information of the area determined as the second area and the model information and the medium information included in each piece of the inspection result data 163 plotted in this area. The control section 150 causes the generated color number determination information 167 to be stored in the storage 160 (step S18).

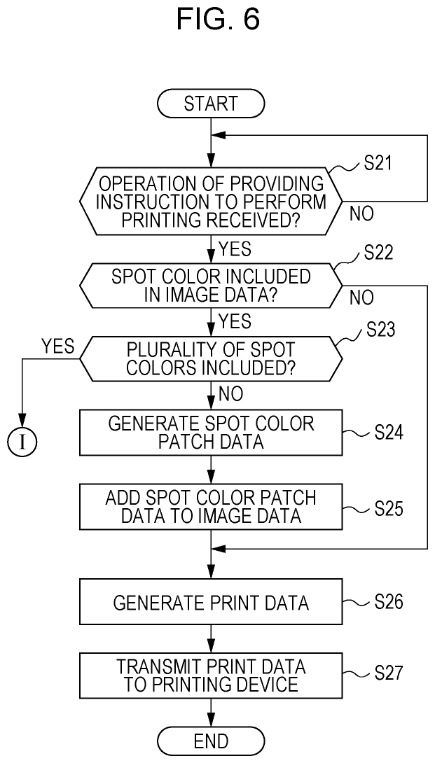

FIG. 6 is a flowchart illustrating operations of the information processing device 100. In particular, FIG. 5 is a flowchart illustrating operations of transmitting image data to the printing device 10 to cause the printing device 10 to print the image data.

With reference to the flowchart illustrated in FIG. 6, operations of the information processing device 100 will be described.

First, the control section 150 determines whether the operation section 133 has received an operation of providing an instruction to perform printing (step S21). If the operation of providing an instruction to perform printing has not been received (No at step S21), the control section 150 stands by until the operation of providing an instruction to perform printing is received.

If the operation of providing an instruction to perform printing is received (Yes at step S21), the control section 150 determines whether a spot color is included in image data selected by the received operation (step S22). If a spot color is not included in the selected image data (No at step S22), the control section 150 applies processing such as rasterization to the image data, thereby generating print data (step S26). Then, the control section 150 transmits the generated print data to the printing device 10 specified by the operation (step S27).

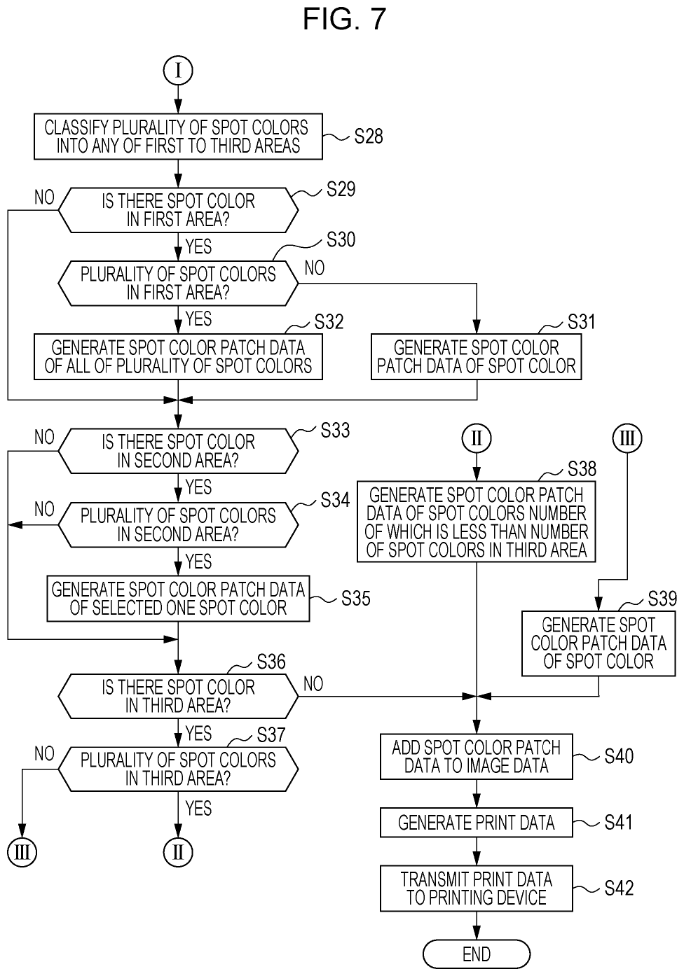

In addition, if a spot color is included in the image data (Yes at step S22), the control section 150 determines whether a plurality of spot colors are included in the image data (step S23). Operations performed when a plurality of spot colors are included in image data will be described with reference to the flowchart illustrated in FIG. 7.

If the plurality of spot colors are not included in the image data (No at step S23), the control section 150 generates spot color patch data of the spot color included in the image data (step S24). The control section 150 adds the generated spot color patch data to the image data (step S25) and applies processing such as rasterization to the image data to which the spot color patch data has been added, thereby generating print data (step S26). Then, the control section 150 transmits the generated print data to the printing device 10 specified by the operation (step S27).

FIG. 7 is a flowchart illustrating operations of the information processing device 100. In particular, FIG. 7 is a flowchart illustrating operations performed when a plurality of spot colors are included in image data.

With reference to the flowchart illustrated in FIG. 7, operations of the information processing device 100 will be described.

If a plurality of spot colors are included in the image data (Yes at step S23), the control section 150 classifies the plurality of spot colors into any of the first to third areas based on the color number determination information 167 (step S28).

Then, the control section 150 determines, based on a determination result at step S28, whether there is a spot color classified into the first area (step S29). If there is not a spot color classified into the first area (No at step S29), the control section 150 proceeds to a determination at step S33.

If there is a spot color classified into the first area (Yes at step S29), the control section 150 determines whether a plurality of spot colors are classified into the first area (step S30).

If a plurality of spot colors are not classified into the first area (No at step S30), the control section 150 generates spot color patch data of one spot color classified into the first area (step S31) and proceeds to a determination at step S33.

If a plurality of spot colors are classified into the first area (Yes at step S30), the control section 150 generates spot color patch data of all of the plurality of spot colors classified into the first area (step S32) and proceeds to a determination at step S33.

Then, the control section 150 determines, based on a determination result at step S28, whether there is a spot color classified into the second area (step S33). If there is not a spot color classified into the second area (No at step S33), the control section 150 proceeds to a determination at step S36.

If there is a spot color classified into the second area (Yes at step S33), the control section 150 determines whether a plurality of spot colors are classified into the second area (step S34).

If a plurality of spot colors are not classified into the second area (No at step S34), the control section 150 proceeds to a determination at step S36, without generating spot color patch data of a spot color classified into the second area.

If a plurality of spot colors are classified into the second area (Yes at step S34), the control section 150 generates spot color patch data of one spot color selected among the spot colors classified into the second area (step S35) and proceeds to a determination at step S36.

Then, the control section 150 determines, based on a determination result at step S28, whether there is a spot color classified into the third area (step S36). If there is not a spot color classified into the third area (No at step S36), the control section 150 proceeds to step S40.

If there is a spot color classified into the third area (Yes at step S36), the control section 150 determines whether a plurality of spot colors are classified into the third area (step S37).

If a plurality of spot colors are not classified into the third area (No at step S37), the control section 150 generates spot color patch data of one spot color among spot colors classified into the third area (step S39) and proceeds to step S40.

If a plurality of spot colors are classified into the third area (Yes at step S37), the control section 150 selects spot colors the number of which is less than the number of spot colors classified into the third area. The control section 150 generates spot color patch data of the selected spot colors (step S38).

Then, the control section 150 adds the generated spot color patch data generated at at least one of steps S31, S32, S35, S38, or S39 to the image data (step S40). Then, the print control section 150 applies processing such as rasterization to the image data to which the spot color patch data has been added, thereby generating print data (step S41). The control section 150 then transmits the generated print data to the printing device 10 specified by an operation (step S42).

### 5. MODIFICATIONS

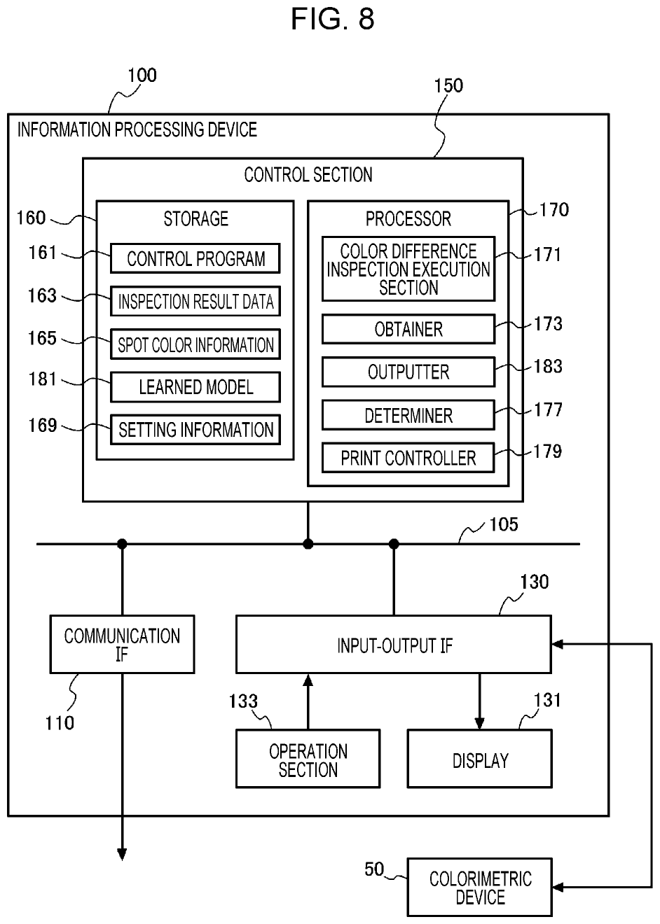

FIG. 8 is a block diagram illustrating the configuration of a modification of the information processing device 100.

In the information processing device 100 according to the modification illustrated in FIG. 8, the storage 160 stores a learned model 181. In addition, the control section 150 includes an outputter 183 as a functional block instead of the generator 175.

The inspection result data 163 generated by the information processing device 100 according to the modification includes the color information of a spot color for which an inspection result of the color difference inspection is defective, and the color information of a spot color for which an inspection result of the color difference inspection is good.

To generate the learned model 181, the information processing device 100 learns a correspondence between the color information of a spot color included in the inspection result data 163 and inspection result information indicating whether the result of a color difference inspection for the spot color is good or defective. The learned model 181 is a model learned, for example, by machine learning such as deep learning. The learned model 181 consists of so-called neural networks. The learned model 181 is supervised using the color information of a spot color included in the inspection result data 163.

By inputting, to the learned model 181, color information to be printed as a spot color patch by the printing device 10, the outputter 183 obtains, from the learned model 181, information indicating whether the color indicated by the input color information is a color that is likely to cause a color difference in a color difference inspection. The outputter 183 outputs the obtained information indicating whether the color is likely to cause a color difference in a color difference inspection. The outputter 183 may output, as the information indicating whether the color is likely to cause a color difference, information indicating to which of the first area, the second area, and the third area the input color information belongs.

### 6. OTHER ASPECTS

The embodiments described above are desirable embodiments of the present disclosure. However, the present disclosure is not limited to the embodiments described above and may be implemented in various modified manners without departing from the spirit and scope of the present disclosure.

For example, although, in the embodiments described above, a description has been given of the case in which the colorimetric device 50 is externally coupled to the information processing device 100, the configuration may be such that the printing device 10 includes the colorimetric device 50 and may be such that the printing device 10 is externally coupled to the colorimetric device 50.

For example, although, in the embodiments described above, a description has been given of the case in which the information processing device 100 performs a color difference inspection to generate the color number determination information 167, the configuration may be such that the printing device 10 includes a colorimetric sensor and the printing device 10 performs a color difference inspection. In addition, the printing device 10 may transmit the inspection result data 163 generated by performing a color difference inspection to a server device (not illustrated) coupled to the network 30. The server device generates the color number determination information 167 based on the received inspection result data 163.

In addition, although, in the embodiments described above, a description has been given of the configuration in which the colorimetric device 50 is externally coupled to the information processing device 100 and a colorimetric value of the colorimetric device 50 is input to the information processing device 100, the user may see a spot color patch printed on a print medium and operates the operation section 133 to input information on whether the result of a color difference inspection is good or defective.

In addition, a color that is included in the print data and uses spot color ink may be set as a spot color. The printing device 10 prints a spot color patch using spot color ink on a print medium.

In addition, the functional units of the information processing device 100 illustrated in FIG. 1 indicate the functional configuration, and their specific implementation forms are not limited. That is, hardware individually corresponding to the functional sections may not be implemented, and, of course, the configuration may be such that the functions of a plurality of functional units are implemented by a single processor executing a program. In addition, some of the functions implemented by software in the embodiments described above may be implemented by hardware, and, in addition, some of the functions implemented by hardware may be implemented by software. Furthermore, the specific detailed configurations of the other components of the information processing device 100 may be arbitrarily changed without departing from the spirit and scope of the present disclosure.

In addition, the processing units of the flowcharts illustrated in FIGS. 4 to 7 are divided according to the main processing contents to ease understanding of the processing of the information processing device 100. The present disclosure will not be limited by how the processing units of the flowcharts in FIGS. 4 to 7 are divided and what are the names of the processing units. In addition, according to the processing content, the processing of the information processing device 100 may be divided into more processing units or may be divided such that one processing unit includes more processing. In addition, the order of processing of the flowcharts mentioned above is not limited to the examples illustrated in the figures.

### 7. OVERVIEW OF PRESENT DISCLOSURE

The following appendices provide an overview of the present disclosure.

Appendix 1: An information processing device comprising:
an obtainer configured to obtain color information of a patch targeted for a color difference inspection and inspection result information indicating a result of the color difference inspection for the patch;
a determiner configured to determine, among colors included in image data, a color to be printed as the patch based on the color information and the inspection result information; and
a print controller configured to cause a printing device to print the image data and the patch of the color determined by the determiner, wherein
the determiner is configured to change a number of colors to be printed as the patch based on the inspection result information on the colors included in the image data.

According to this configuration, the number of colors to be printed as patches among colors included in image data is determined based on inspection result information on a color difference for each of the patches. Therefore, the number of colors of patches is determined based on the past inspection result information on color differences, and thus an appropriate number of patches may be printed, which enables color adjustment with a smaller number of patches. This may reduce the costs of color difference inspections and reduce the man-hours for the color difference inspections, causing the color difference inspections to be efficiently performed.

Appendix 2: The information processing device according to appendix 1, wherein the determiner is configured to:
identify, based on the color information and the inspection result information, a first area and a second area for which the inspection result information indicates that the result is defective, the first area being a color area in which a number of patches determined as being defective is greater than or equal to a first threshold, the second area being a color area in which the number of patches determined as being defective is less than or equal to a second threshold less than the first threshold, and
make the number of patches of a color included in the second area smaller than the number of patches of a color included in the first area.

According to this configuration, printing is performed such that the number of patches of the color included in the second area is smaller than the number of patches of the color included in the first area. This may reduce the number of patches to be printed each of which is unlikely to cause a defect result of a color difference inspection, thereby reducing the costs of color difference inspections. In addition, by reducing the number of patches to be printed each of which is unlikely to cause a defect result of a color difference inspection, the man-hours for the color difference inspections may be reduced, which enables the color difference inspections to be performed efficiently.

Appendix 3: The information processing device according to appendix 1 or 2, wherein
the obtainer is configured to obtain model information identifying a model of a printing device that printed the patch targeted for the color difference inspection, and
the determiner is configured to, when the printing device is a different model from a model of a printing device indicated by the model information, make a number of patches to be printed by the printing device smaller than a number of patches to be printed by the printing device when the printing device is the same model as the printing device indicated by the model information.

According to this configuration, when the printing device is a different model from the model indicated by the model information, the number of patches to be printed is made smaller than the number of patches to be printed when the printing device is the same model as the printing device indicated by the model information. This may reduce the number of patches to be printed each of which is unlikely to cause a defect result of a color difference inspection, thereby reducing the costs of color difference inspections. In addition, by reducing the number of patches to be printed each of which is unlikely to cause a defect result of a color difference inspection, the man-hours for the color difference inspections may be reduced, which enables the color difference inspections to be performed efficiently.

Appendix 4: The information processing device according to any one of appendices 1 to 3, wherein
the obtainer is configured to obtain medium information indicating a print medium on which the patch was printed, and
the determiner is configured to, when the printing device performs printing on a different print medium from the print medium indicated by the medium information, make a number of patches to be printed smaller than a number of patches to be printed when the printing device performs printing on the same print medium as the print medium indicated by the medium information.

According to this configuration, when the printing device performs printing on a different print medium from the print medium indicated by the medium information, the number of patches to be printed is made smaller than the number of patches to be printed when the printing device performs printing on the same print medium as the print medium indicated by the medium information. This may reduce the number of patches to be printed each of which is unlikely to cause a defect result of a color difference inspection, thereby reducing the costs of color difference inspections. In addition, by reducing the number of patches to be printed each of which is unlikely to cause a defect result of a color difference inspection, the man-hours for the color difference inspections may be reduced, which enables the color difference inspections to be performed efficiently.

Appendix 5: The information processing device according to appendix 1, further comprising:
an outputter configured to output information indicating whether a color indicated by color information is a color that is likely to cause a color difference in the color difference inspection, by inputting the color information to be printed as a patch by the printing device to a learned model that learned a correspondence between color information of the patch and the inspection result information indicating an inspection result of the color difference inspection.

According to this configuration, by inputting, to the learned model, color information to be printed as a patch by the printing device, it may be determined at high accuracy whether an inspection result is defective when a color difference inspection is performed for the patch of a color indicated by the color information.

Appendix 6: The information processing device according to any one of appendices 1 to 5, wherein
the printing device is configured to print an image based on the image data and a spot color patch of a color using a spot color ink included in the image data on a single print medium.

According to this configuration, a printed product in which an image based on image data and a spot color patch of a color using a spot color ink included in the image data are printed on a single print medium may be obtained.

Appendix 7: A non-transitory computer-readable storage medium storing a program that causes a computer to function as:
an obtainer configured to obtain color information of a patch targeted for a color difference inspection and inspection result information indicating a result of the color difference inspection for the patch;
a determiner configured to determine, among colors included in image data, a color to be printed as the patch based on the color information and the inspection result information; and
a print controller configured to cause a printing device to print the image data and the patch of the color determined by the determiner, wherein
the determiner is configured to change a number of colors to be printed as the patch based on the inspection result information on the colors included in the image data.

According to this configuration, the number of colors to be printed as patches among colors included in image data is determined based on inspection result information on a color difference for each of the patches. Therefore, the number of colors of patches is determined based on the past inspection result information on color differences, and thus an appropriate number of patches may be printed, which enables color adjustment with a smaller number of patches. This may reduce the costs of color difference inspections and reduce the man-hours for the color difference inspections, causing the color difference inspections to be efficiently performed.

What is claimed is:

1. An information processing device comprising:
an obtainer configured to obtain color information of a patch targeted for a color difference inspection and inspection result information indicating a result of the color difference inspection for the patch;
a determiner configured to determine, among colors included in image data, a color to be printed as the patch based on the color information and the inspection result information; and
a print controller configured to cause a printing device to print the image data and the patch of the color determined by the determiner, wherein
the determiner is configured to change a number of colors to be printed as the patch based on the inspection result information on the colors included in the image data.

2. The information processing device according to claim 1, wherein the determiner is configured to:
identify, based on the color information and the inspection result information, a first area and a second area for which the inspection result information indicates that the result is defective, the first area being a color area in which a number of patches determined as being defective is greater than or equal to a first threshold, the second area being a color area in which the number of patches determined as being defective is less than or equal to a second threshold less than the first threshold, and
make the number of patches of a color included in the second area smaller than the number of patches of a color included in the first area.

3. The information processing device according to claim 1, wherein
the obtainer is configured to obtain model information identifying a model of a printing device that printed the patch targeted for the color difference inspection, and
the determiner is configured to, when the printing device is a different model from a model of a printing device indicated by the model information, make a number of patches to be printed by the printing device smaller than a number of patches to be printed by the printing device when the printing device is the same model as the printing device indicated by the model information.

4. The information processing device according to claim 1, wherein
the obtainer is configured to obtain medium information indicating a print medium on which the patch was printed, and
the determiner is configured to, when the printing device performs printing on a different print medium from the print medium indicated by the medium information, make a number of patches to be printed smaller than a number of patches to be printed when the printing device performs printing on the same print medium as the print medium indicated by the medium information.

5. The information processing device according to claim 1, further comprising:
an outputter configured to output information indicating whether a color indicated by color information is a color that is likely to cause a color difference in the color difference inspection, by inputting the color information to be printed as a patch by the printing device to a learned model that learned a correspondence between color information of the patch and the inspection result information indicating an inspection result of the color difference inspection.

6. The information processing device according to claim 1, wherein the printing device is configured to print an image based on the image data and a spot color patch of a color using a spot color ink included in the image data on a single print medium.

7. A non-transitory computer-readable storage medium storing a program that causes a computer to function as:
an obtainer configured to obtain color information of a patch targeted for a color difference inspection and inspection result information indicating a result of the color difference inspection for the patch;
a determiner configured to determine, among colors included in image data, a color to be printed as the patch based on the color information and the inspection result information; and
a print controller configured to cause a printing device to print the image data and the patch of the color determined by the determiner, wherein
the determiner is configured to change a number of colors to be printed as the patch based on the inspection result information on the colors included in the image data.
